(19) United States
(12) Patent Application Publication
(10) Pub. No.: US 2005/0041636 A1
(43) Pub. Date: Feb. 24, 2005

(54) Method for routing data packets in a packet-switching communication network having several network nodes

(76) Inventors: Andreas Iselt, Germering (DE); Gero Schollmeier, Gauting (DE); Christian Winkler, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/918,850

(22) Filed: Aug. 13, 2004

(30) Foreign Application Priority Data
Aug. 14, 2003 (DE) 10337465.5

(51) Int. Cl. H04L 12/28

(52) U.S. Cl. 370/351

(57) ABSTRACT

Data packets are forwarded in the network nodes of the communication network by a multipath routing method and multiprotocol label switching in at least one part of this communication network.

### CROSS REFERENCE TO RELATED APPLICATIONS

This application claims priority to the German application No. 10337465.5, filed Aug. 14, 2003 and which is incorporated by reference herein in its entirety.

### FIELD OF INVENTION

The invention relates to a method for routing data packets in a packet-switching communication network having several network nodes.

### BACKGROUND OF INVENTION

Various routing methods are used for routing, automatic alternative routing, forwarding or for the transmission of data packets with a destination address, such as Internet protocol packets (IP packets) or protocol data units (PDUs), from a transmitter to a receiver in a packet-switching communication network having several network nodes such as routers, switches or gateways, like Internet protocol networks (IP networks) or open system interconnect networks (OSI networks). The routing determines the path that the data packets take from the transmitter to the receiver, the respective destination, destination network node or destination system.

### SUMMARY OF INVENTION

To achieve a higher level of fail-safe security in the transmission of data packets, multipath routing is used. This is used to substantially reduce the reaction times and impairment in quality in the event of failures in network nodes, connecting paths or links.

In the case of multipath routing, successive packets or groups of packets (flows) are transmitted through various or several paths from the transmitter to the receiver corresponding to a specified traffic distribution that is determined in each case by a preset traffic distribution weighting. The traffic distribution weighting specifies the traffic loading per path for a destination address or connecting path. The traffic distribution weighting is normally a value between 0 and 1 with 0 standing for no traffic and 1 for maximum traffic on a connection or path. A traffic distribution weighting of 1 means that all packets are transmitted via this path. In the case of multipath routing, where several parts are available, the traffic is distributed according to the weighting. The total of the traffic weighting to a destination in a network node is accordingly 1, i.e. 100% of the traffic.

In the case of multipath routing where there is a possibility of faster local error reactions in each network node of the communication network, an increased reliability can then be achieved only if at least two paths via different links to the required destination or destination network node are available at each network node involved. This is called outdegree 2 or O2. Otherwise, a link failure could interrupt the connection in the direction of the destination. Accordingly, with multipath routing

a) more than one path, i.e. at least one alternative path to the destination must be available in a network node. In this way, a fast local reaction to link failures is possible. Furthermore,

b) the linking of the multipath routing paths between the network nodes and through several network nodes must not lead to looping. Routing loops lead to circuits of packets in the network. Circuiting packets increase the loading of the links and network nodes in the data network, and thus also reduce the transport capacity of the network and lead to substantial unnecessary packet delays or to packet losses.

Conditions a) and b) are counteractive to the extent that the avoidance of routing loops frequently leads to a reduction in the multipath routes or paths to a destination that are possible and can be used.

This is illustrated by an example. FIG. 1 shows an arrangement of part of a packet-switching communication network, for example, an IP network consisting of three network nodes A, B, C, that are connected to each other via connections or links AB, AC and BC in a triangle. Network nodes A and B have connections to a part of the data network (not illustrated) through which they receive the data packets. Data packets intended for a destination Z (not illustrated) and connected to network node C or for network node C itself are considered.

For normal shortest-path routing, data packets for network node C received from network node A are sent via connection AC to network node C. In the same way, data packets received from network node B for network node C are sent via connection BC to network node C.

The routing tables with regard to the forwarding of packets that have the destination address of network node C would thus be as follows.

| | |
|---|---|
| Destination | Connecting path |

In node A:

| | |
|---|---|
| C | AC |

In node B:

| | |
|---|---|
| C | BC |

For multipath routing or multipath forwarding, the following alternative routes would be suitable: Network node A could forward packets to network node C also via connection AB to network node B if they are being forwarded from there via connection BC to network node C.

Equally, network node B could forward packets to network node C via connection AB to network node A if they are being forwarded from there via connection AC to network node C. The routing tables, including the traffic distribution weightings p₁ and p₃ for the alternative routes would then be as follows.

| | | |
|---|---|---|
| Destination | Connecting path | Weight |

In node A:

| | | |
|---|---|---|
| C | AC | 1 − p₁ |
| C | AB | p₁ |

In node B:

| | | |
|---|---|---|
| C | BC | 1 − p₃ |
| C | AB | p₃ |

If this routing table were used for a purely destination-based forwarding decision, then the case that a packet from network node A would be forwarded on the route to network node C, first through connection AB to network node B and then again from network node B via connection AB to network node A would have the probability p₁p₃. This would occur to a packet twice in succession with the probability (p₁p₃)². The probability for an n-times forward and backward sending of a packet would be (p₁p₃)ⁿ. Thus, the forwarding of packets from network node A to network node C would not be realized without looping.

In an older German patent application of the applicant with the DPMA application identification number 10301265.6, a solution to the aforementioned problem is proposed in that the traffic distribution is omitted and instead the network nodes would be given locally executable rules. The traffic distribution weight for the critical alternative paths, i.e. the potential loops, is then minimized, i.e. set at zero. The paths are, however, entered in the routing table and marked as “joker links”. Furthermore, the nodes now apply the rule that they use only the links provided with the minimum traffic distribution weight if the required neighboring router or next hop cannot be reached by any other route that has a positive weight. This simple expansion of the principle of the purely destination-based multipath forwarding of packets solves the problem of the circulating packets. The advantage of this method is that a loop-free alternative route is made available for multipath routing.

This method is explained by means of an example. FIG. 1 shows the arrangement, already described in the introduction, of part of a packet-switching data network. Starting from the procedure described there, we now get the following entries, for the known method, for network node C in the routing table of network nodes A and B.

| | | |
|---|---|---|
| Destination | Connecting path | Weight |

In node A:

| | | |
|---|---|---|
| C | AC | 1 |
| C | AB | 0 |

In node B:

| | | |
|---|---|---|
| C | BC | 1 |
| C | AB | 0 |

A packet arriving at network node A for forwarding to network node C is normally forwarded via the primary connection AC to network node C. Only if network node A detects that connection AC has failed, is the distribution weight changed locally and the packets for network node C are forwarded via the alternative routing path AB to network node B. The entries in the routing table of network node A in the event of failure of connection AC are then as follows.

In node A:

| Destination | Connecting path | Weight |
|---|---|---|
| C | AB | 1 |

Network node B in turn forwards the packet only direct via its primary connection BC to network node C, because, according to the same rule, it uses only the entry for network node C in its routing table that has a positive weight.

When realizing the multipath routing in real networks, some problems occur. In particular, these are as follows.

When routing with exactly two paths and there is a failure of a link, only one path is available to the destination node. Because it generally takes a relatively long time for a link to be repaired, a second link could fail in this period, so that a so-called “end-to-end” relationship could be partially interrupted or a quality of service, as it is called, may no longer be guaranteed because of overload. The same applies if N paths, whereby N>2, are available and N−1 paths have failed.

The use of the joker link method is simply not possible with today's network nodes.

In weak or unsatisfactory interlinked or meshed nodes, it can occur that a network node has two or more links, but due to topological limitations and/or because of the necessary freedom from looping of the routes it cannot use these links together or partially. Frequently in this case, fast local alternative switching using a joker link is not possible.

No suitable measures are as yet known for solving the problems given as an example and the resulting consequences.

An object of the invention is therefore to provide a further method for routing of data packets in a packet-switching communication network that, with regard to the mentioned problems, affords an additional possibility in the choice of alternative routes.

This object is achieved by the claims.

The advantage of the method is that with the use of multiprotocol label switching (MPLS) in selected parts of the communication network otherwise operated with multipath routing, loop-free alternative paths are available and a loop-free traffic distribution can be carried out. By the selective application of MPLS, alternative routes can be made available in the event of failures of network nodes or links.

Advantageous developments of the invention are given in the dependent claims.

In an advantageous development of the invention, the alternative forwarding of the data packets takes place by MPLS relative to the destination address of the data packet. The advantage of this is that the number of MPLS paths used is minimized.

In an advantageous development of the invention, MPLS alternative connecting paths are established in the event of failure of a connecting path. The advantage of this is that the failed connecting path is replaced and, furthermore, a loop-free traffic distribution can be carried out in accordance with the multipath routing. The establishment of the MPLS alternative connecting paths can take place relative to the destination address. For example, different MPLS alternative connecting paths can be set up for different destination addresses. This means that at least two loop-free paths for traffic distribution are available in a network node, and the condition for so-called O2 nodes is fulfilled.

Exemplary embodiments of the invention are explained in more detail below with the aid of drawings.

### BRIEF DESCRIPTION OF THE DRAWINGS

These are as follows:

FIG. 1 Part of a communication network with three network nodes and first MPLS paths.

FIG. 2 Part of a communication network with five network nodes and second MPLS paths.

FIG. 3 Part of a communication network with five network nodes and third MPLS paths.

FIG. 4 Part of a communication network with six network nodes and fourth MPLS paths.

FIG. 5 Part of a communication network with six network nodes and fifth MPLS paths.

### DETAILED DESCRIPTION OF INVENTION

With multiprotocol label switching (MPLS), network-wide conditions are maintained that define the routes or paths via which packets are routed through the network while bypassing the “normal” routing. In this case, the network nodes no longer forward packets using the destination IP addresses of the packets, but instead a bit sequence (label) is assigned to each packet at the entry to the network. This label, that is evaluated in each network node and also changed if necessary, determines the path on which the packets are forwarded. The relationship between labels and paths must be established when commissioning the network. The label is again removed at the exit from of the network.

By using multiprotocol label switching, all traffic relationships, i.e. all source and destination network node relationships for data packets on “edge-to-edge” paths between the network nodes of the network are depicted. This procedure leads to a “full intermeshing” path. This results in a high complexity of traffic relationships or a high management complexity of O(N²). In the network, this means that a number of status information items must be managed for MPLS. This is undesirable in many cases.

With a method in accordance with the invention, MPLS is used only at selected points of the network. By means of a selected use of a few MPLS paths, problems of the multipath routing are avoided.

In contrast to its “normal” use, MPLS is not used in the form of edge-to-edge paths but instead amid the network directly between network nodes or “core routers” This results in a hybrid operation with multipath routing and alternative MPLS. The network operates as before as a routed IP network but many IP next hops are realized through MPLS path sections via several network nodes. This means that by means of an MPLS path that leads from a first network node via several further network nodes to a second network node the second network node is a quasi direct neighbor of the first network node.

In the following, it is assumed that after switching an MPLS path that can run through several network nodes, this is automatically monitored for functional capability. This can take place by means of a keep-alive signal between the start and end of the path or by an MPLS end-to-end protection. In this way, the failure of an MPLS path should be quickly detected and a fast local alternative switching for the failed MPLS path found.

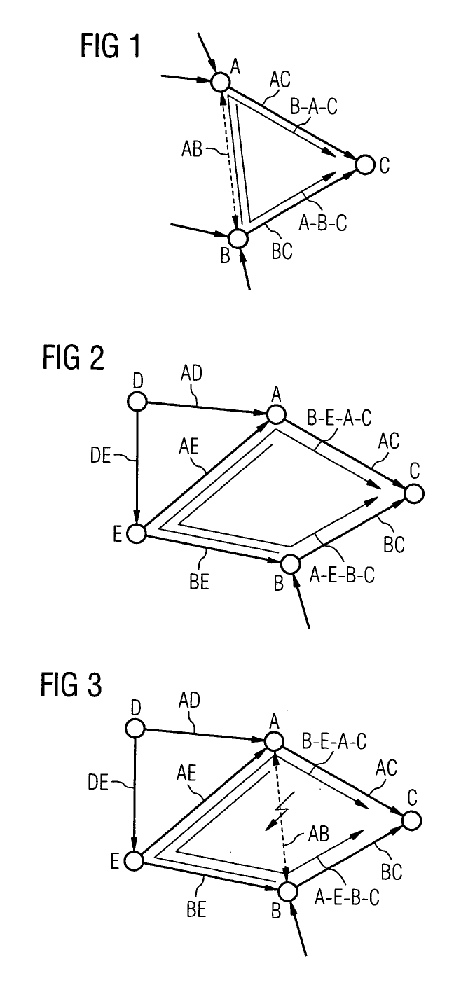

FIG. 1 shows part of a communication network, already described in the introduction, such as an IP network, consisting of three network nodes A, B and C that are connected to each other by a connecting path, a link or an AB, AC or BC connection. Network nodes A and B have further connections to parts of the communication network (not illustrated).

Data packets that are received at network nodes A and B and destined for destination node C are considered.

With respect to the problem of traffic distribution with multipath routing and the freedom from looping of the multipath routes, described in the introduction, multiprotocol label switching (MPLS), is used in the network shown in FIG. 1 in such a way that both an A-B-C MPLS path from network node A via network node B to network node C and also an B-A-C MPLS path from network node B via network node A to network node C is established. In this way, network nodes A and B become full-value O2 nodes in accordance with multipath routing.

FIG. 2 shows part of a communication network with five network nodes A, B, C, D and E that are linked to each other via several connections AC, AD, AE, BC, BE and DE. Only those data packets for destination network node C that are received at network node B, or network node A from the part of the network not illustrated, are considered. In this case, no connection AB exists for which a full-value O2 routing could be used. A full-value O2 routing is enabled by the MPLS paths A-E-B-C and B-E-A-C. In this way, network nodes A, B, D and E can be protected by a local reaction if connection AC or B fails.

FIG. 3 is an illustration according to FIG. 2 but with the condition that a connection AB exists between network nodes A and B. This connection AB is disturbed and is replaced by MPLS paths A-E-B-C and B-E-A-C set up as an alternative. This is comparable with FIG. 2. In this way, an alternative path is available at each network node. The quality of service (QoS) is also guaranteed in the event of a further failure of a connection.

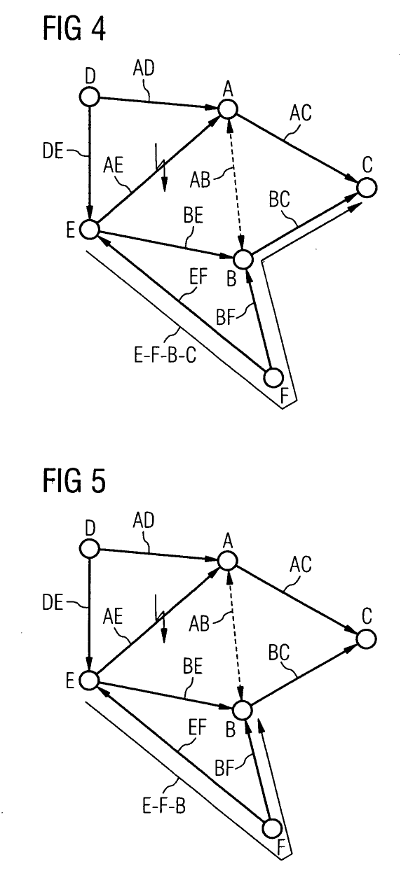

FIG. 4 shows an arrangement in accordance with FIG. 3, with the condition that a further network node F is provided that is connected with network nodes B and E by means of two connections BE and BF. It is assumed that connection AB is disturbance-free and connection AE is disturbed. After detecting the disturbance in connection AE, traffic for the destination network node C is captured at network node E by a fast local switching to connection BE. An MPLS alternative path E-F-B-C is set up or switched as a preventative measure. Network node E again obtains two paths in the direction of destination network node C or the O2 property. If connection BE were now to fail, further traffic could flow through MPLS path E-F-B-C.

FIG. 5 shows an arrangement according to FIG. 4, with the condition that the alternative MPLS path E-F-B-C in this case leads only to network node B, i.e. an MPLS path E-F-B is established. In this case, the alternative MPLS path is set up to network node B. Network node B in this case has two paths to destination network node C. The first leads direct via connection BC and the second is via network node A, i.e. connections AB and AC. This is the preferred use of MPLS alternative paths according to the invention.

The method in accordance with the invention can be used if purely O2 routing does not enable a satisfactory load distribution or if multipath routing cannot provide at least two loop-free next hops for all network nodes.

The basic idea of the invention is to always use MPLS if undesirable weak points remain due to the sole use of O2 routing or if an O2 through routing is not possible. In particular, it can be ensured when dealing with link failures that a second path can be provided after a second substantially more unlikely link failure. In this way, spontaneous re-routing, that would sometimes substantially impair the quality of service of traffic flows, can be avoided in many cases, provided the network topology permits.

By means of this hybrid operation, the good scaling properties of IP routing and the facility for load distribution via several links is maintained, MPLS alone is not supported and obtains a facility for solving, in a simple manner, problems of O2 routing that occur on a case basis.

The MPLS technology is presently available with the IP routing in modern network nodes or routers, that support both technologies.

1-5. (cancelled)

6. A method for routing data packets in a packet switching communication network having several network nodes, wherein data packets in the network nodes can be forwarded by a multipath or multipath routing method and wherein in at least one part of this communication network data packets are alternatively forwarded by multiprotocol label switching.

7. The method according to claim 6, wherein MPLS paths are used within the network.

8. The method according to claim 6, wherein the alternative forwarding of data packets by multiprotocol label switching or MPLS paths in the network nodes takes place depending on the destination address of the data packet.

9. The method according to claim 7, wherein the alternative forwarding of data packets by multiprotocol label switching or MPLS paths in the network nodes takes place depending on the destination address of the data packet.

10. The method according to claim 6, wherein the forwarding of data packets by multiprotocol label switching or MPLS paths takes place in parts of the communication network in which, by use of the multipath or multipath routing method, no adequate load distribution and/or quality of service is achieved.

11. The method according to claim 7, wherein the forwarding of data packets by multiprotocol label switching or MPLS paths takes place in parts of the communication network in which, by use of the multipath or multipath routing method, no adequate load distribution and/or quality of service is achieved.

12. The method according to claim 8, wherein the forwarding of data packets by multiprotocol label switching or MPLS paths takes place in parts of the communication network in which, by use of the multipath or multipath routing method, no adequate load distribution and/or quality of service is achieved.

13. The method according to claim 6, wherein an MPLS alternative connecting path is set up in the event of failure of a connecting path of a network node.

14. The method according to claim 7, wherein an MPLS alternative connecting path is set up in the event of failure of a connecting path of a network node.

15. The method according to claim 8, wherein an MPLS alternative connecting path is set up in the event of failure of a connecting path of a network node.

16. The method according to claim 10, wherein an MPLS alternative connecting path is set up in the event of failure of a connecting path of a network node.
